(19) United States
(12) Patent Application Publication
(10) Pub. No.: US 2022/0339981 A1
(43) Pub. Date: Oct. 27, 2022

(54) HYBRID TRANSIT VEHICLE TRANSIT SYSTEM AND ASSEMBLAGE THEREOF

(71) Applicant: Kenneth Earl Martin, Morrison, CO (US)

(72) Inventor: Kenneth Earl Martin, Morrison, CO (US)

(21) Appl. No.: 17/240,439

(22) Filed: Apr. 26, 2021

(51) Int. Cl. B60F 1/00; B61F 3/04; B60F 1/02

(52) U.S. Cl. CPC B60F 1/005; B61F 3/04; B60F 1/02; B60F 2301/04; B60F 2301/10

(57) ABSTRACT

Article and means for a hybrid transit vehicle, transit system and assemblage thereof. Vehicle composition may include at least one chassis frame arrangement for a pivoting articulating suspension to position wheel axle to “X” horizontal axis for vehicle modality by wheel contact to ground-based surface and to position wheel axle to “Z” vertical axis for vehicle modality by wheel and utility contact to surface of rail guideway.

### BACKGROUND

Historically, development of personal transportation systems has focused on traditional ground-based surface wheel drive vehicles. In the development of Personal Transit Vehicles (PTV), recent advanced technologies have affected vehicle operation, driver/vehicle interaction and vehicle performance. As PTV volumes increase roadway congestion has followed. While attempts have been made to alleviate congestion by designating lanes for prioritized higher occupancy vehicles (HOV), PTV operation continues to expand without significant reduction of ground level congestion created by PTV's and a multitude of other newly developed ground-based surface operated transportation devices.

Wherein recent and evolving intelligent computing technologies are being applied to PTVs, PTV wheel tracking is maintained on ground-based surface wheel drive's dependency on traditional roadways with less detailed consideration for other means of wheel tracking.

PTV systems ground-based surface wheel drive operation enables traction options through differing wheel tread design. PTV safe operations are effective to the extent of optimal wheel to surface tracking conditions on which they operate.

Intelligent computing technologies applied to PTVs have displaced some traditional operational aspects from human to artificial intelligence (AI). Regardless of the operator being human or AI, optimal PTV development continues to rely on crucial design criteria: control, speed and safety. Developing PTV technologies continue to add features in PTV development though with less appointment to enhance accessibility and maximized AI interface.

PTV development has strived to enhance the transit experience by focusing on personalizing vehicles for private ownership. This continues to be embraced by the public. While there is a portion of the public not wanting to own PTVs, the long-term successes of PTV development are relevant in the continued development of personal transit systems.

The U.S. Department of Transportation, Office of Public Affairs in 2017 published a Federal Highway Administration (FHWA) release, stating the cost of highway construction has risen “by an estimated 68 percent over the last 13 years.” While automobile costs have inflated during the same time by around 6.51 percent. This dependent relational context suggests that automobile manufacturing efficiencies are a significant basis for continued development of PTV's and with less reliance on traditional roadways.

Public transit systems costs are typically paid through public trusts, general treasury funds and user taxes. Where PTVs are predominantly owned and maintained by the user, this helps to avert transit system costs borne by the public and is worthy of continued application in the development of financially sustainable PTV systems.

PTV systems ground-based surface wheel drive operation enables traction options by various wheel design. PTV safe operations are effective to the extent of optimal wheel to surface tracking conditions on which they operate.

While PTV high-speed operation on ground-based surface road surfaces enhances events of higher risk, there is less option to experience personal high-speed travel on a public routes with uniform optimal crash control and response mechanisms.

PTV development has incorporated a marked evolution of improvement in performance, fuel efficiency, dependability and safety. Wherein vehicle operator distraction accounted for some 391,000 injuries reported in 2017, there is apparent need to develop vehicles that enhance rider experience while continuing to maintaining and improve current PTV standards and operational efficiencies, including: alternative power sourcing, scale, user adaptability, private/public use, societal integration, adaptability and competitive vehicle marketing.

While transit distances among urban and suburban residents are about equal, commutes are now “reversing,” moving from urban to suburban work locations. Consequently there is less criteria suggesting that fixed route Bus or Light Rail Transportation is either efficient or effective in serving dynamic populations with static transit modes. The maintained success of the PTV is founded on passenger travel option and preference.

Transit intermodal connectivity is critical in substantiating public use and acceptance of a transportation system. Traditional ground-based surface transit systems infrastructure disjoins communities and their natural ground forms. As a result we rely on “paratransit” complements, as required by the Americans with Disabilities Act of 1990 (ADA). Great opportunities are present in transit systems that better enhance community connectivity.

Wherein transit options have begun development in response to environmental concerns, there is continued opportunity for PTV system development responses that are more environmentally responsible, sustainable and secure.

Developing countries are challenged with traditional PTV systems development threatening natural environments that sustain plant and animal species within delicate ecosystems. Where the people of the world depend on the natural sustainable health of our planet, there exists an opportunity to stem a repetitive mass development of traditional ground-based surface wheel drive transportation.

Wherein traditional PTV systems are developed with added focus on climate effect, continued sensitive transit systems development will contribute to minimizing added impermeable and heat gaining ground cover with contribution to the sustenance of our natural environment.

Numerous mechanical systems enhance traditional PTV vehicle systems operation, including resource regeneration. While there are many PVT features designed in complement of vehicle operation, added benefit of enhanced PTV systems development may entail the distribution of utility service to route host communities.

Mass Transit, either ground-based or elevated track or rail-guided systems are less considerate of historically applied and accepted PTV based design criteria. PTV hybrid development has many opportunities for enhancement, such as: door-to-door routing, scheduling and parcel transport.

Mass Transit drive mechanisms vary greatly with each system employed. The Standard and Narrow Gauge Railroads exemplify the importance of setting standards and gauging for a transit system to accommodate continued expansion. Wherein Mass Transit systems may eventually achieve a standard guideway specification and gauge, expandable transit systems development is dependent on guideway gauging.

Worldly sustainability concerns have evolved criteria that sensitive transit development has opportunity to address. Currently, PTVs and other ground-surface based transit infrastructure offer less feature of this significance.

Sensitive transit systems development minimizing added heat gain and impermeable ground cover will contribute to the sustenance of our long-term natural environment. Current PTV systems are developed with less significant focus on this factor.

Developing countries need an opportunity to forego a more traditional transit system development and the subsequent displacement of natural habitat for ground-based surface wheel drive vehicle's infrastructure. A system providing a “lighter touch” development is worthy criteria for transit development in the more natural landscape as well as in the more populated urban community.

### SUMMARY

Exemplary embodiment here, in article full and in part, discloses a Hybrid Transit vehicle (HTv) HTv transit system as individual article and as composite in assemblage of articles. HTv article may entail and join article of enclosure, chassis, power, motor, drive transfer, drive engagement, suspension, axle, axle drive engagement, steering, steering engagement and wheel. HTv Rail guideway inclusion thereof may entail and join article of profile, traction surface, utility conveyance, power conveyance, switch track, support, HTv to rail guideway mount and dismount, and HTv scan.

### BRIEF DESCRIPTION OF THE SEVERAL VIEWS OF THE DRAWING

Description of the disclosed idea is further exemplified herein by figure embodiment or articles in complement to the HTv and HTv System and the Assemblage thereof and of which should be conjunctive in consideration of the idea. The patent or application file contains at least one drawing executed in color. Copies of this patent or patent application publication with color drawing(s) will be provided by the Office upon request and payment of the necessary fee.”

FIG. 1 Perspective Views—1A HTv right front view exemplifying HTv in transparent composite engaged for HTv modality on rail guideway and 1B HTv right front view exemplifying HTv in opaque composite with HTv engaged for modality on rail guideway.

FIG. 2 Perspective View—HTv right rear view exemplifying HTv rear chassis and HTv suspension with HTv suspension and HTv drive engaged to HTv onboard motor with HTv wheel axle in “X” (horizontal) axis for HTv ground-based surface modality.

FIG. 3 Perspective View—HTv front chassis and HTv suspension exemplified with HTv rail guideway modality drive engaged and HTv steering disengaged with HTv wheel axle in “Z” (vertical) axis for HTv rail guideway modality.

FIG. 4 Perspective Views—Multiple HTv suspension views exemplify HTv suspension in pivot motion sequence rotating about HTv suspension pivot axis. 4A HTv wheel positions as viewed from HTv front and exemplifying HTv right front wheel suspension pivot motion sequence from (forward) HTv rail guideway engagement and modality position to (back) HTv ground-based surface modality 4B HTv wheel positions as viewed from HTv rear and exemplifying HTv right front wheel suspension pivot motion sequence from (forward) HTv ground-based surface modality to (back) HTv rail guideway engagement and modality.

FIG. 5 Perspective Views—5A HTv right front view exemplifying HTv addressing rail guideway. 5B Rail guideway entrance exemplifying HTv screening and sequence scanning HTv chassis on rail guideway exemplifies HTv in idle mode and HTv staging for HTv rail guideway route readiness.

FIG. 6 Perspective View—Exemplifying HTv in rail guideway modality as viewed from underside of rail guideway.

FIG. 7 Perspective Views—Exemplifying HTv articles in relational position to HTv and HTv to rail guideway engagement. 7A exemplifies a set of two HTv idler carriages in position of both left and right of the rail guideway. 7B Exemplifies HTv articles assembly sequence from right to left in partial exemplification of HTv chassis and frame in a sequential assemblage and in relation to rail guideway.

FIG. 8 Perspective View—Exemplifying HTv front articles in relational position to HTv and HTv to rail guideway engagement. 8A Exemplifies HTv drive and steering pivot articles as partial to HTv complete article. 8B Exemplifies HTv articles comprising the Hybrid Transit vehicle partial front chassis and frame.

FIG. 9 Top and Rear Views—Exemplifying HTv composite. 9A HTv top view exemplifies full HTv chassis, battery, power, suspension and wheel assemblage and in relation to rail guideway. 9B HTv exemplified from HTv rear in transparent composite engaged for modality on rail guideway.

FIG. 10 Perspective Views—Exemplifying HTv in route from HTv ground-based surface modality and transitioning to HTv rail guideway modality in urban setting. 10A Front right view exemplifying a plurality of HTv engaging rail guideway with suspension and wheel pivot to rail guideway for HTv rail-guided modality 10B Right rear view exemplifying a plurality of HTv transitioning from HTv ground-based surface travel and engaging scanner, rail guideway mount and suspension and wheel pivot to rail guideway for rail-guided modality.

FIG. 11 Perspective View—Exemplifies a plurality of stationary HTv, HTv in transit on ground-based surfaces wheel drive and a plurality of HTv in route on elevated rail guideway. Rail guideway exemplifies transit system switch track and articles for harvesting power and water resources.

FIG. 12 Perspective View—Exemplifying HTv articles in relational position to HTv and HTv to rail guideway engagement. Embodied herein is article assemblage in mid-pivot position.

FIG. 13 Perspective View—Exemplifying HTv elevated rail guideway system with column supported solar/rainwater/communication receptor panels and column water storage cistern feature.

FIG. 14 Perspective View—Exemplifying HTv elevated rail guideway system with column supported solar/rainwater/communication receptor panels, column water storage cistern feature and rail guideway exit platform with ladder.

FIG. 15 Perspective View—Exemplifying HTv partial front chassis in rail guideway transit modality.

### DETAILED DESCRIPTION

Representation of a Hybrid Transit vehicle (HTv), a Transit System and an Assemblage Thereof is disclosed with less added description of conventional article or assemblage of conventional articles indicated and with intent to clarify the HTv and HTv Transit System and Assemblage Thereof.

This exemplary embodiment, in full article and in partial article, discloses the Hybrid Transit vehicle and HTv Transit System as individual article and as composite in assemblage of articles. A Hybrid Transit vehicle inclusion may entail and join article of enclosure, chassis, power, motor, drive transfer, drive engagement, suspension, axle, axle drive engagement, steering, steering engagement and wheel. A hybrid transit vehicle rail guideway inclusion thereof may entail and join article of rail guideway system and method including profile, traction surface, utility conveyance, switch track, support, HTv to rail guideway alignment, scanning, data linking, mounting, staging, switching and dismount.

A Hybrid Transit vehicle (HTv) pertains to the HTv that functions as transit in dual modality. The exemplary embodiment is of the HTv incorporating a conventional suspension system with alternative suspension positioning, providing for hybrid transit modality in ground-based surface wheel drive or rail guideway wheel drive.

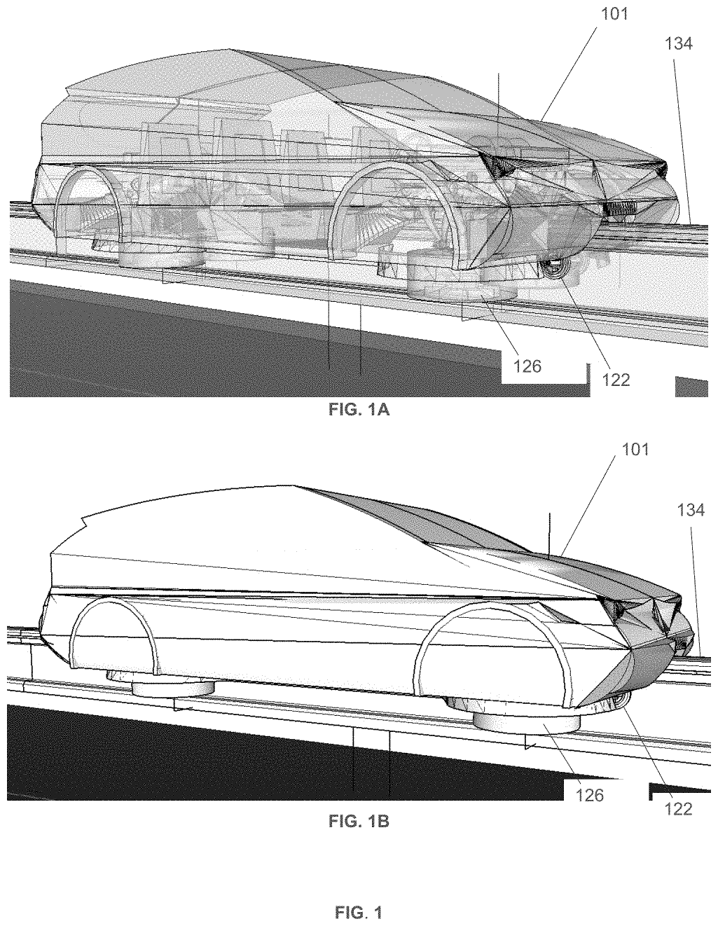

Exemplary references FIGS. 1-12 embody the HTv 101 and an HTv chassis 103 which may be in proportionate scale and operation of conventional ground-based surface wheel drive vehicles. Interior HTv fitment and controls may entail conventional vehicle provision and may entertain added feature of instrumentation and controls including linking HTv 101 data with HTv occupant data of transit need or preference with transit system data, such to enhance the HTv 101 modality experience. HTv 101 system gauging may incorporate crash avoidance and crash sequencing controls in managing HTv 101 response to transit system fault.

Exemplary references FIGS. 1-12 embody the article and means for the HTv 101, the transit system and assemblage thereof. The HTv 101 power options may include an electric motor 116 powered for low mileage ground-based surface wheel drive by on board battery power sourcing. Power regeneration and charging options may include regenerative power sourcing by a restorative braking/generator/motor/idler carriage 105 in duality. The idler carriage 105 may provide various HTv 101 modal functions, including braking assistance, low-geared HTv 101 slow modality during HTv 101 staging on the rail guideway 134, and freewheeling during high-speed modality on the rail guideway 134. Power regeneration for an onboard battery 124 in duality may be provided also by the rail guideway 134 and plug in power bars 143 located each side of the rail guideway 134 top flange which carry power for the HTv 101 conveyance on the rail guideway 134. Rail power is captured via a power collector bow 123 in plurality and located as part of a rail guideway gyro-wheel idler carriage 122 which rotates into contact with the rail guideway power bars 143 as the HTv 101 rear pivot suspension 106 and a front directional pivot suspension 107 rotates from ground-based surface modality into rail guideway transit modality.

Exemplary embodiment FIG. 1 the HTv 101 transparent FIG. 1A and opaque FIG. 1B composite illustrate the HTv 101 engaged on and for rail guideway 134 modality. The HTv 101 article assemblage and form contribute to the HTv 101 balance and transfer of forces on the rail guideway 134. During HTv 101 rail 134 operation, imposed loads on the rail 134 may be effectively transferred to the rail 134 by the idler carriage 122 and an HTv wheel 126 in duality for each front and rear axle of the HTv 101. The rail guideway 134 structure, support, elevation and span may entail design in response to the HTv 101 static and dynamic load imposition as well as exposure to dynamic instances, such as wind, earthquake and flood. The rail guideway 134 system may entail strategic placement in relation to a varying mix of environmental criteria, such as climate, natural habitat or built environment.

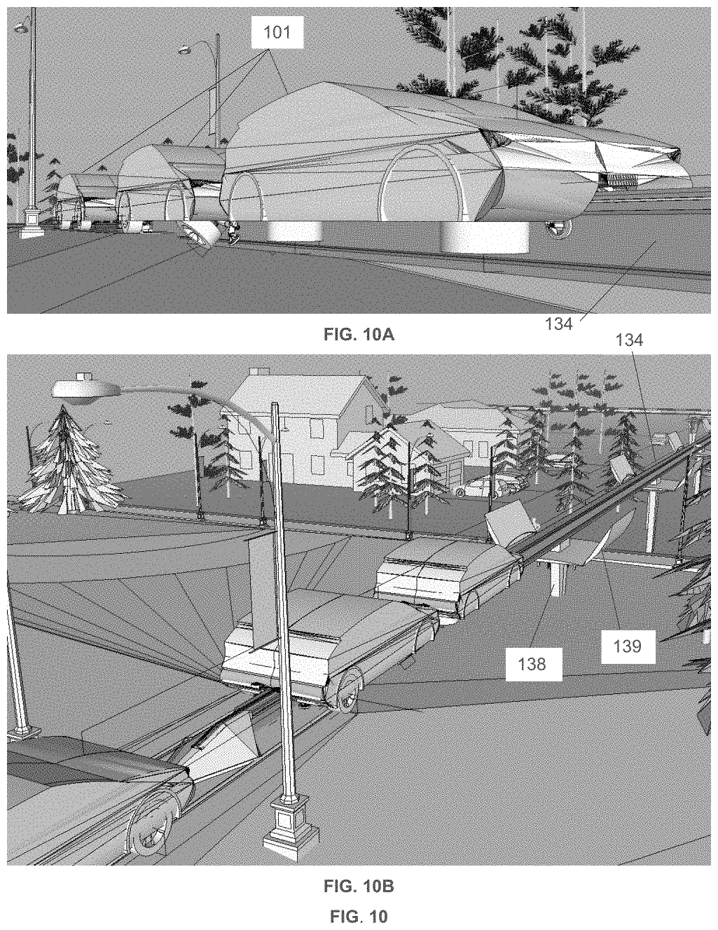

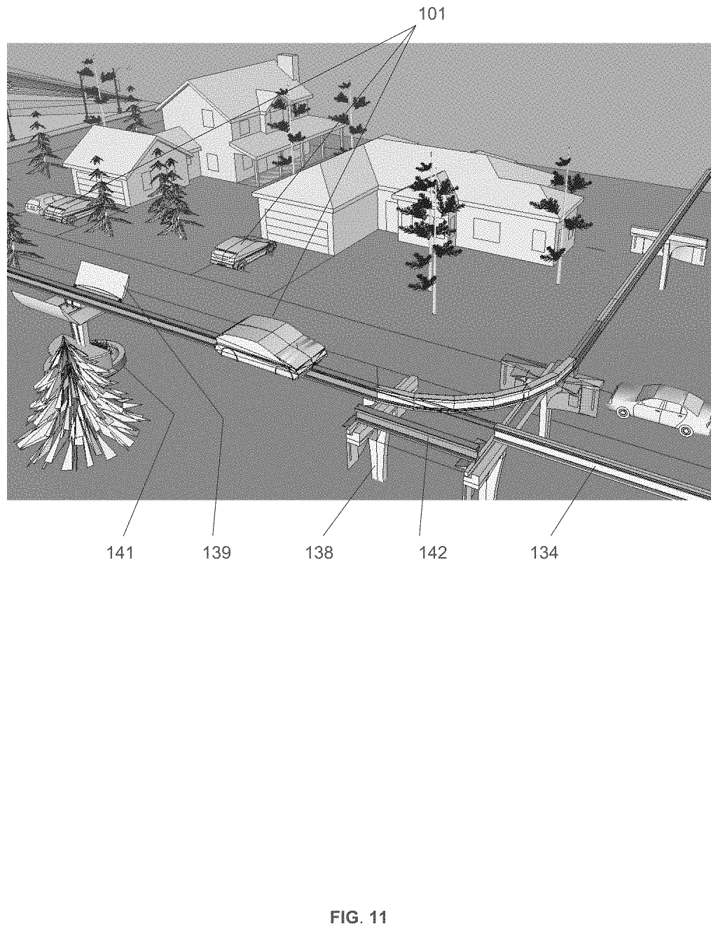

Exemplary embodiment FIG. 10 and FIG. 11 illustrate the HTv 101 and the rail guideway 134 in relation to the environment. The elevated rail guideway 134 may relieve existing ground-based wheel drive transit systems overburden as well as provide a lighter footprint in developing transit through lands with more delicate ecosystems. The lightweight HTv 101 and HTv system may also affect repurposing abandoned R.O.W. in maintaining viable connectivity of smaller rural communities.

Exemplary embodiment FIG. 10 and FIG. 11 illustrates a rail 134 system with means to harvest natural resources and provide in route communications for passengers. A rail guideway solar/rainwater/communications collector panel 139 may feature on rail guideway support columns 138 where HTv systems are developed in climates suiting collection of resources prime to community livelihood. The panels 139 may flank the rail guideway 134 at the various column 138 locations. The panels 139 may be equipped for solar energy collection and electrical current contribution to the HTv system. The panel 139 water run off may direct and filter through replaceable carbon filters to drain down and service local cistern resources that may be built at ground level about the various columns 138. The panel 139 directional positioning may contribute to satellite communications reception and transmission where remote transmission continuity is sparse.

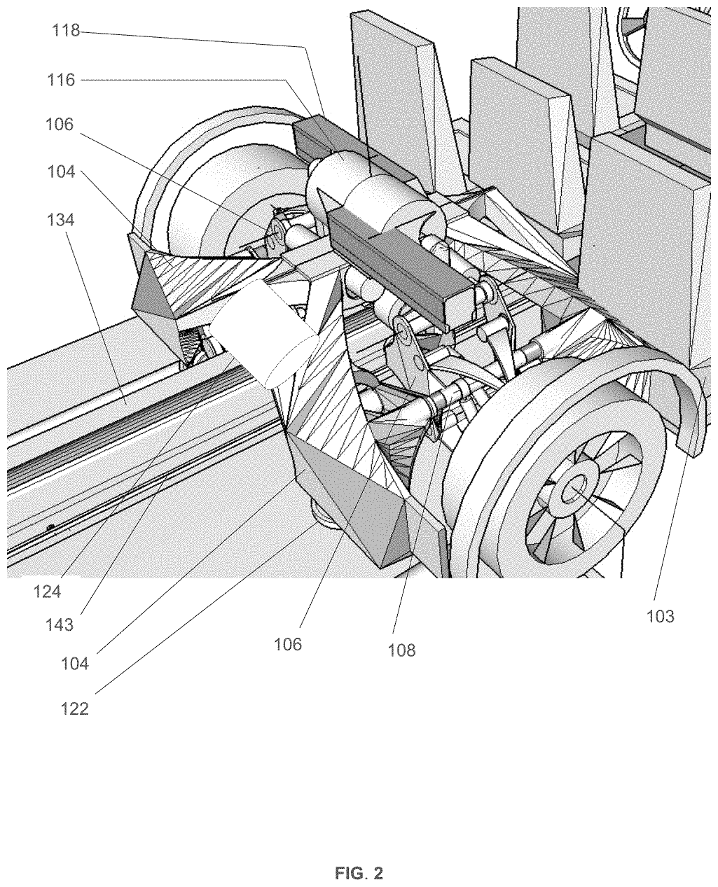

Exemplary embodiment FIG. 2 illustrates the HTv back partial chassis 103 article assemblage and the HTv in ground-based surface wheel drive transit modality ready for suspension partial rotation to rail 134 modality. The stationary electric motor 116 and a motor drive transfer case 118 may center on and connect to a chassis pivot suspension frame 104 for ready maintenance access. As the HTv receives an electronic queue initiating rail transit modality from road modality the pivot suspension 106 may partially rotate on a pivot suspension pivot spindle 108 to position for modality on the rail guideway 134. As the pivot suspension 106 partially rotates the idler carriage 122 with current collector bow 123 also partially rotates into position to make current contact with the rail power bar 143. The chassis 103 and the chassis pivot suspension frame 104 may be dimensionally clear of the rail guideway 134 when the HTv 101 is in rail guideway 134 modality to enable the rail guideway 134 turning radii to simulate turning radii of a common conventional ground-based surface wheel drive vehicles. The idler carriage 122 during ground-based surface wheel drive modality may clear ground comparable to conventional vehicles.

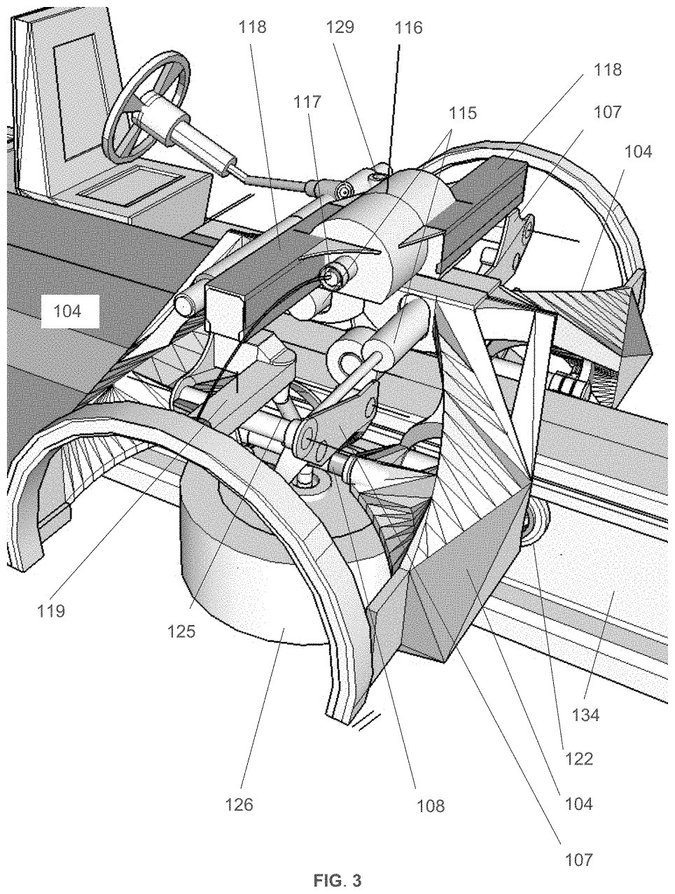

Exemplary embodiment FIG. 3 illustrates the HTv front partial chassis 103 article assemblage in rail guideway 134 transit modality. The electric motor 116 and the transfer case 118 may connect to top of the chassis pivot suspension frame 104 for ready maintenance access. An electronic transit modality queue may partially rotate the pivot suspension 107 on the pivot suspension pivot spindle 108 by the pneumatic piston actuator 115 during the HTv staging for modality onto or off the rail guideway 134. The pivot suspension 107 rotation action to rail 134 modality couples drive gearing from the transfer case 118 to the transfer case 119 to axle 125 and wheel 126 in rail 134 modality. Reverse partial rotation of pivot suspension 107 couples transfer case 119 with motor coupler 117 directly for ground-based surface wheel drive modality. The chassis 103 and the chassis pivot suspension frame 104 may be dimensionally clear of the rail guideway 134 when the HTv 101 is in rail guideway 134 modality to enable Htv turning radii to simulate turning radii of a common conventional ground-based surface wheel drive vehicle when engaged in rail guideway 134 modality.

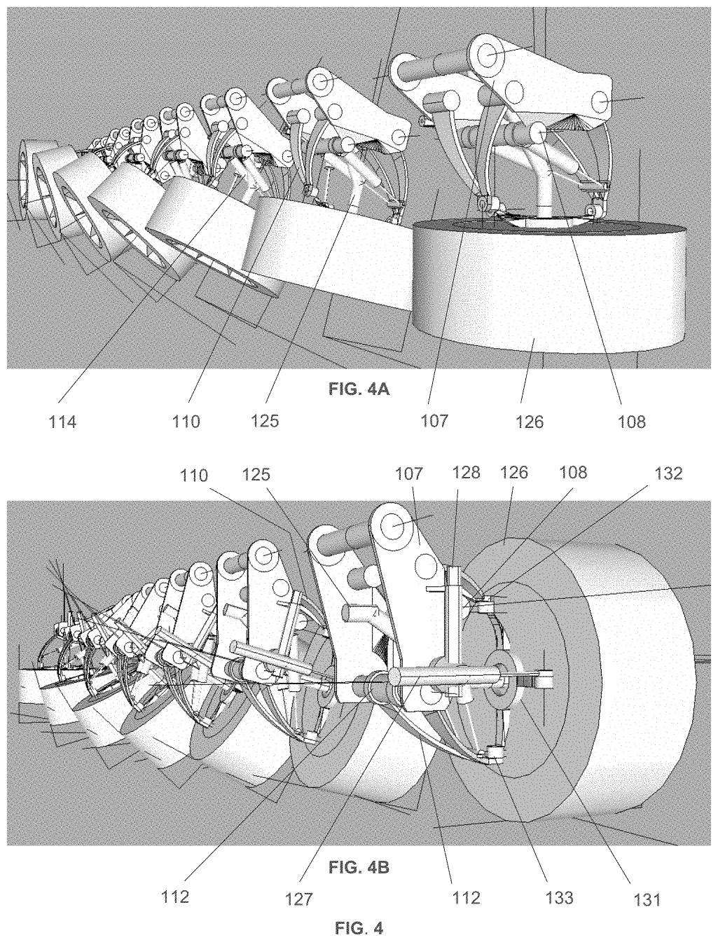

Exemplary embodiment FIG. 4 illustrates the pivot suspension 107, consisting of an assembly of two substantially parallel plates with spindle cross members for connection of substantially parallel plates, wherein suspension articles connect to spindle cross members and a suspension rotation axis is set and centered through one spindle for the pivot suspension 107 attachment to chassis suspension frame and in substantial alignment with suspension articles that couple for engagement of steering and drive, enabling a steerable HTv. The pivot suspension 107 is illustrated in pivot sequence about a pivot suspension pivot spindle 108. FIG. 4A illustrates the HTv wheel 126 in partial rotation sequence as viewed from HTv front to back and exemplifying HTv right front pivot suspension 107 partial rotation motion sequence from rail guideway 134 modality to ground-based surface wheel drive modality. FIG. 4B The HTv wheel 126 in partial rotation sequence as viewed from HTv back and exemplifying HTv right front pivot suspension 107 including: the wheel 126, a steering knuckle 131, an upper ball joint 132, a lower ball joint, 133, a steering post linkage 127, a steering post coupler 128, the axle 125, and a strut 114 in duality, an upper control arm 110, a lower control arm 112, a lower control arm bushing shaft 113 in partial rotation motion sequence from ground-based surface wheel drive modality to rail guideway 134 modality. The pivot suspension 106 and the pivot suspension 107 complete with the wheel 126 article assemblage may simulate proportion and scale as conventional ground-based surface wheel drive vehicles.

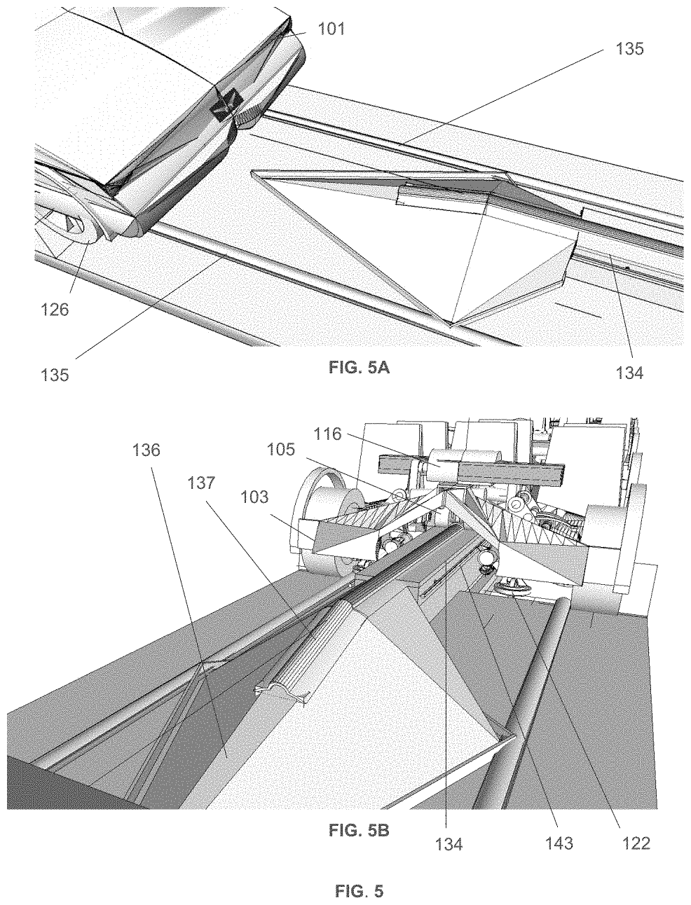

Exemplary embodiment FIG. 5A illustrates the HTv 101 in approach of rail guideway 134 and with front wheel 126 in duplicity in guidance by a rail guideway vehicle approach track 135 and in approach of the rail guideway 134. FIG. 5B illustrates the HTv back chassis pivot suspension frame 104 portion in rail 134 staging mode with idler carriage 105 on top of rail guideway 134. This sequence contacts the idler carriage 105 sensor plate to the vehicle rail mount staging strip 137 and executes HTv staging. The carriage 105 initial contact with the staging strip 137 queues the HTv motor 116 disengagement while the idler carriage 105 creeps the HTv forward through staging sequences including HTv scanning by a rail guideway security and sequence scanner 136. The Hybrid Transit vehicle rail mount staging strip 137 guides the HTv 101 slowly forward while linking data of the HTv 101 to the rail guideway 134 to transit system central operational controls. A data link may include: the HTv condition, location, proximity and passenger preference of route, schedule and in route entertainment and other data services deliverable via HTv system for or from passenger or parcel. The idler carriage 122 during ground-based surface wheel drive modality may clear ground comparable to conventional vehicles when HTv is in both ground and rail modality.

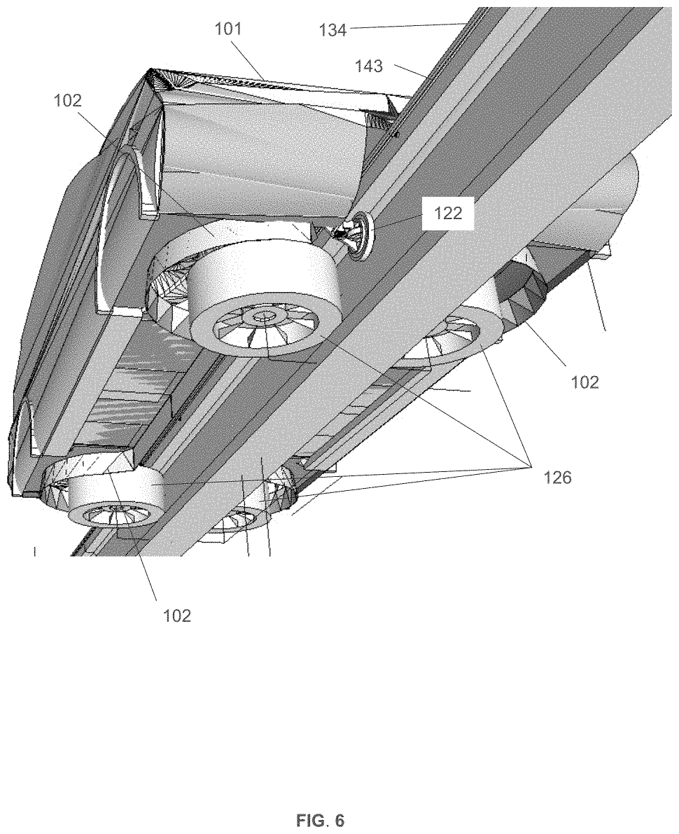

Exemplary embodiment FIG. 6 illustrates the HTv 101 in rail guideway 134 modality with the idler carriage 122 and the wheel 126 engaged to the rail guideway 134 and the rail guideway power bar 143 for HTv high-speed transit. An under tray air dam 102 at each wheel may be arranged to avert the HTv 101 upward lift and wheel 126 drift on rail guideway surface.

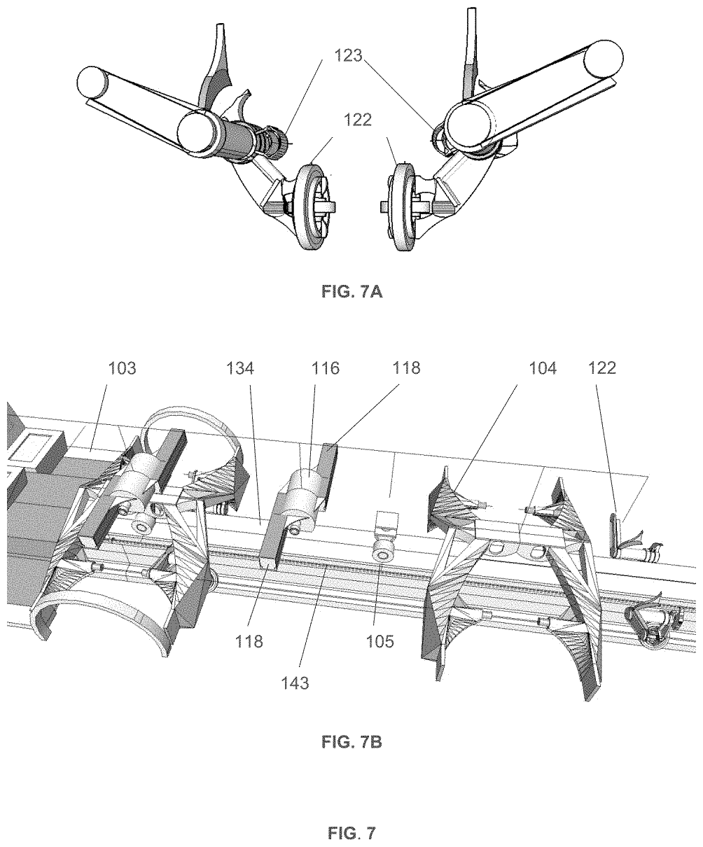

Exemplary embodiment FIG. 7A illustrates a set of rail guideway gyro wheel idler carriage 1.6.0 of articles assemblage may attach to the chassis pivot suspension frame 104 and may partially rotate from an upward position during the HTv 101 ground-based surface wheel drive to a lowered position during rail guideway 134 engagement. The idler carriage 122 may partially rotate in sequence to HTv staging onto or off of the rail guideway. Exemplary embodiment FIG. 7B illustrates the HTv partial assemblage routine may entail collection and lineal assemblage of HTv articles in a sequence: the idler carriage 122 connected to the chassis pivot suspension frame 104 connected to the idler carriage 105 and for positioning on simulated rail 143, then connection of the motor 116 with the transfer case 118 in duality on the frame 104 to produce partial chassis for connection to the chassis 103.

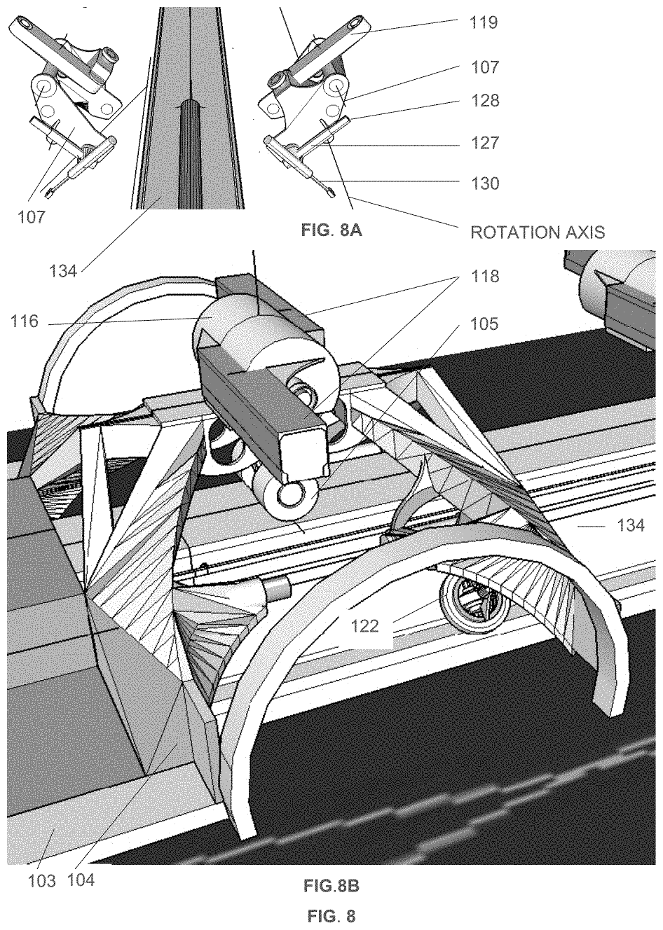

Exemplary embodiment FIG. 8A illustrates a partial directional pivot suspension may entail article of the transfer case 119, and steering articles including: the ring and pinion steering post linkage 127 with the steering post coupling 128 and a steering tie rod 130, all to partially rotate with the complete pivot suspension 106 and pivot suspension 107 from position entertaining ground-based surface wheel drive modality to rail guideway 134 transit modality. Exemplary embodiment FIG. 8B illustrates a partial chassis assemblage of article with the idler carriage 105 which may be centered on rail guideway 134 top resilient surface. The idler carriage 105 located under the front and back frames 104 may entail vibration isolation in mitigation of transit vibration transference to the chassis 103.

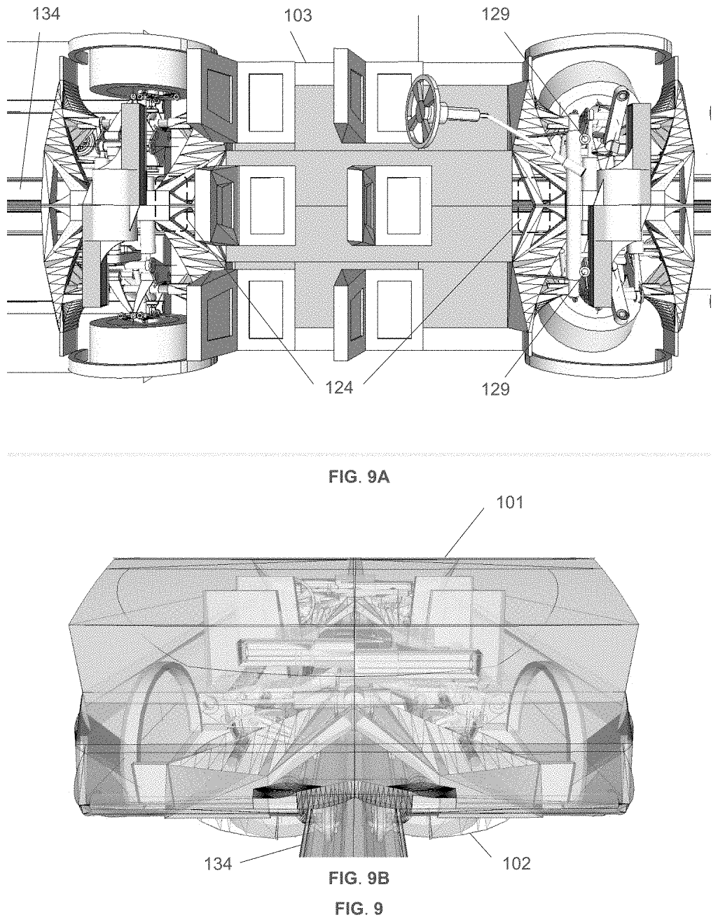

Exemplary embodiment FIG. 9A illustrates the top view of a complete HTv article assemblage of the chassis 103, with front wheels 126 in partial rotation motion addressing rail 134 modality and back wheels 126 in ground-based surface wheel drive modality which stabilizes the vehicle while in modality transition. The steering rack couplers 129 may locate each end of a transverse steering rack and positioned to receive steering linkage coupling when the HTv stages for ground modality. An arrangement of the HTv interior, including seating and operational fitment may entail jurisdictional and operator prescription. The onboard battery 124 location may be within the chassis pivot suspension frame 104 for ready access under the HTv while the HTv is in ground modality. Exemplary embodiment FIG. 9B illustrates a complete article of the HTv 101 assemblage for transit on the guideway 134 may include enclosure profile surrounding HTv occupancy as preferred. The HTv 101 high-speed transit mode may employ under tray air dam 102 in plurality and at each wheel to avert up lift air forces.

Exemplary embodiment FIG. 10 illustrates the Hybrid Transit vehicle system involving the HTv 101 in each ground-based surface wheel drive modality and rail guideway 134. FIG. 10A the HTv 101 of conventional scale and operation for private ownership and use or public use in a leasing or rental capacity. A Rail guideway 134 routing and location of rail guideway entry and exit may involve land acquisition, zoning and other private or public jurisdictional processes.

Exemplary embodiment FIG. 11 illustrates a means of the rail 134 route change by a rail guideway slide switch track 142. This may enable on-demand route changes or pre-set routing strategies involving passenger preferences, including, scene, schedule, safety, and budget. Routing illustration of the HTv 101 from stationary ground-based surface wheel drive mode start up and continuing onto and by the rail guideway 134 system, then dismounting the rail 134 to again transit via ground-based surface wheel drive mode to destination may be directed by intelligent data computing to the extent of autonomy.

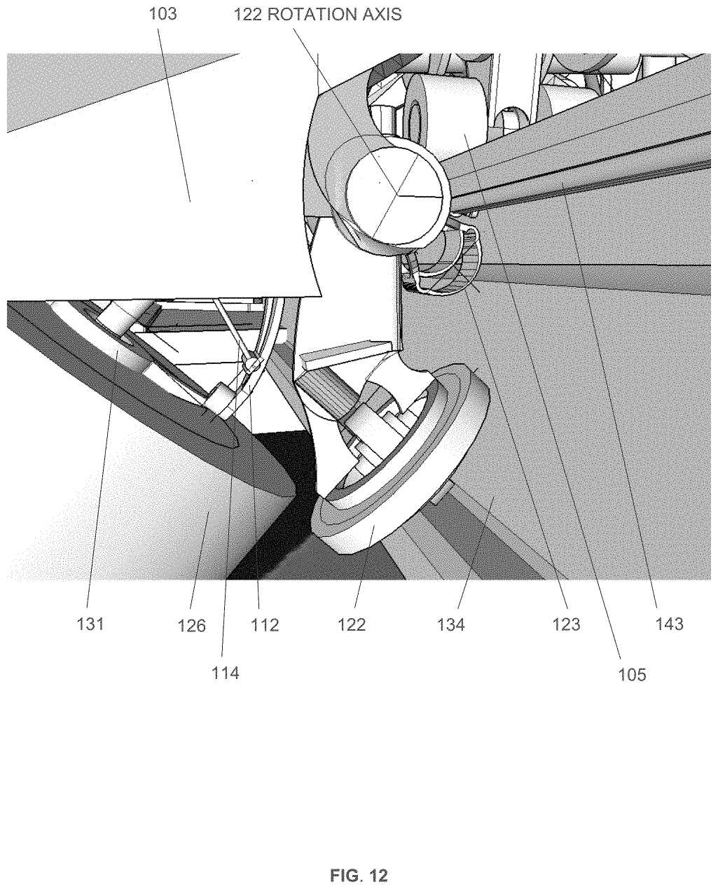

Exemplary embodiment FIG. 12 illustrates a partial article composite of the HTv 101 with the idler carriage 105 atop rail guideway resilient running surface and supporting the frame 104. Affixed to frame 104 the supporting pivot suspension 106 or pivot suspension 107 consisting of article including upper control arm 10, lower control arm 112, the struts 114, the steering knuckle 131, the wheel 126, the idler carriage 122 with the power collector bow 123 all on axis to partially rotate on queue away from rail guideway 134 or toward rail guideway 134 and to contact both the wheel 126 and the power collector bow 123 with rail guideway 134 and power bar 134. The pivot suspension 107 in synchronic partial rotation motion with idler carriage 122 to engage and secure to rail guideway 134 for rail guideway 134 modality.

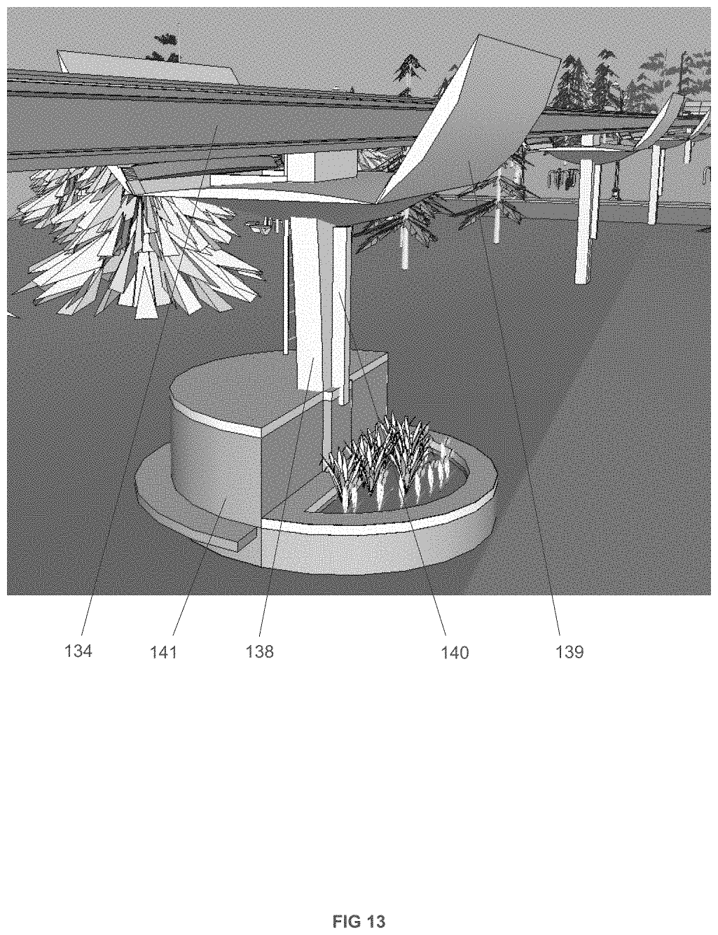

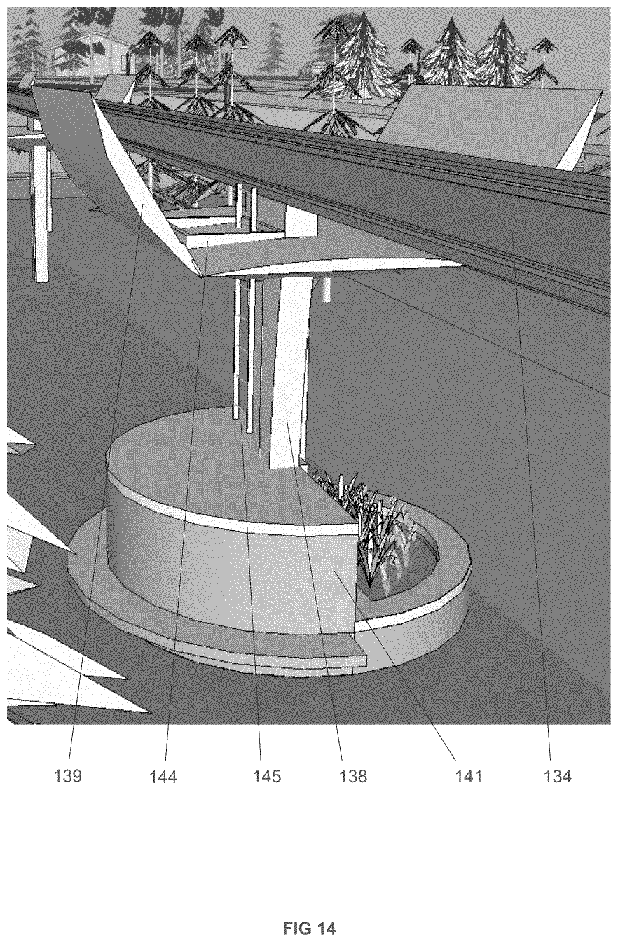

Exemplary embodiment FIG. 13 and FIG. 14 illustrate an elevated HTv rail guideway 134 and the rail guideway support column 138 with the solar/rainwater/communications receptor panel 139 and a water collector drainage downpipe 140 to a rail guideway column cistern 141 at ground level. An emergency/maintenance rail guideway exit platform 144 and an exit ladder 145 to be employed by passengers upon the HTv 101 or rail guideway failure.

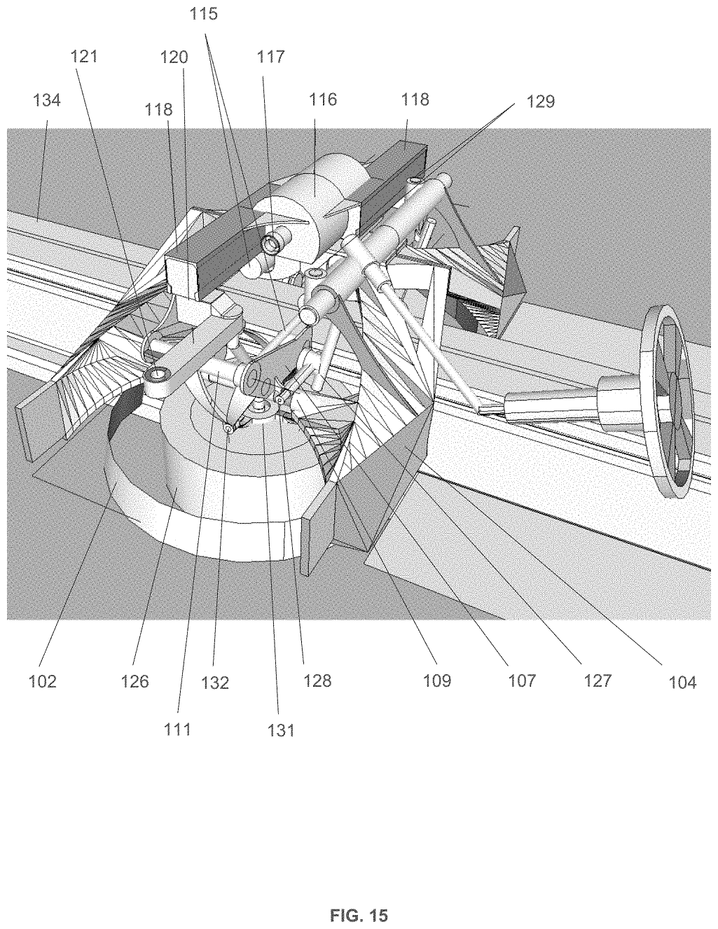

Exemplary embodiment FIG. 15 illustrates the HTv 101 front partial chassis article assemblage in rail guideway 134 transit modality. The electric motor 116 and the transfer case 118 connected to top of the frame 104 positioned for rail guideway 134 modality. Motor and drive transfer case are readily accessible for regular maintenance routines while HTv is stationary and off rail. A transit modality queue partially rotates pivot suspension 107 via the actuator 115 during HTv staging for modality onto or off rail guideway 2.0.0. Partial rotation of pivot suspension 107 couples the transfer case 118, which provides higher geared drive, to a rail drive transfer case coupler 120. The steering post linkage 127 and actuator 115 lock when pivot suspension 107 and the wheel 126 are in rail engagement and aligned for rail guideway 134 modality. As pivot suspension 107 partially rotates about a chassis pivot suspension frame pivot bracket 109 to position for ground-based surface wheel drive modality, the transfer case 119 partially rotates with pivot suspension 107 to couple road drive transfer case coupler 121 with a motor shaft coupler 117. The same pivot suspension 107 partial rotation to ground-based surface wheel drive modality initiates coupling of the steering post coupler 128 with a steering rack coupler 129. The air dam 102 may partially rotate to retract within the HTv 101 wheel well when the HTv 101 in ground-based surface wheel drive modality. The air dam 102 may partially rotate in synchronization with the pivot suspension 106 and pivot suspension 107 to position in skirting the wheels 126 when queued to position for rail guideway 134 transit modality. Conventional suspension components may comprise suspension article, including upper and lower control arm, the steering knuckle 131, the lower ball joint 133 and upper ball joint 132. The pivot suspension 106 and the steerable pivot suspension 107 may comprise of metal form and material to accept conventional suspension article, including lower and an upper control arm bushing shaft 111.

As disclosed, preceding illustrations embodiment exemplifying article of a Hybrid Transit vehicle (HTv). Transit System and Assemblage Thereof is for consideration and with appreciation of article variation within disclosed scope of this embodiment and as claimed herein.

The invention claimed is:

1. A hybrid transit vehicle embodied herein:
an enclosure;
a chassis frame with arrangement for a partially rotating suspension;
an isolation dampened, wheel driven restorative braking generator/motor/idler carriage in plurality, centrally positioned under a vehicle chassis and on wheelbase axis and connected under a chassis suspension frame for alignment with and rotation on a rail guideway top surface;
a partially rotating, independent suspension in plurality of axles and wheels connected to chassis frame and of controlling mechanism addressing position of suspension for vehicle dual modality of ground-based surface wheel drive or wheel drive on surface of rail guideway with inclusion of engagement and disengagement coupling of drive and steering mechanism;
a partially rotating, steerable independent suspension in plurality of axles and wheels connected to chassis frame and of controlling mechanism addressing position of suspension for vehicle dual modality of ground-based surface wheel drive or wheel drive on surface of rail guideway with inclusion of engagement and disengagement coupling of drive and steering mechanism;
a steering rack linkage arrangement for engagement and disengagement from steering post linkage connected to partially rotating suspension;
a partially rotating idler carriage in plurality with power collector connected to under chassis for partial rotation synchronization with suspension and for rail guideway electric current engagement and for aligned securement of hybrid transit vehicle on rail guideway;
an actuator control arm in plurality, positioned substantially centered on chassis and at vehicle wheelbase axis in opposing duality, pivotally connected to chassis frame and extending to partially rotate suspension;
an electric motor with dual transfer case in parallel with motor and connected to chassis in transverse arrangement to chassis, positioned substantially centered on chassis at wheelbase axis,
in which the hybrid transit vehicle wheel axle axis is oriented in the vertical “Z” axis for wheel drive and power engagement on vertical surface of rail guideway; and in which the hybrid transit vehicle wheel axle is oriented in the horizontal “X” axis for ground-based surface wheel drive.

2. The hybrid transit vehicle of claim 1, in which the partially rotating, independent suspension comprises of an assembly of two substantially parallel plates with spindle cross members for connection of substantially parallel plates, wherein suspension articles connect to spindle cross members and a suspension rotation axis is set and centered through one spindle for attachment of suspension to chassis suspension frame at each end of the pivot spindle and in substantial alignment with suspension articles that couple for engagement of drive.

3. The hybrid transit vehicle of claim 1, in which the partially rotating, steerable independent suspension comprises of an assembly of two substantially parallel plates with spindle cross members for connection of substantially parallel plates, wherein suspension articles connect to spindle cross members and a suspension rotation axis is set and centered through one spindle for attachment of suspension to chassis suspension frame at each end of the pivot spindle and in substantial alignment with suspension articles that couple for engagement of steering and drive.

4. The hybrid transit vehicle of claim 1, in which motor and transfer case engage and disengage coupling with wheel drive axle and for vehicle dual modality.

5. A hybrid transit system embodied herein:
Enclosure of articles—
at least one rail comprising of a rail guideway for the hybrid transit vehicle; and
with rail section horizontal top flange and horizontal bottom flange of greater dimensional thickness than rail vertical web; and
of, gauge, segment, radii, cant and material to substantiate high speed hybrid transit vehicle modality thereupon; and
a plurality of continuous rail guideway surface conductive plug-in electric power bars affixed to rail top flange sides; and
a plurality of continuous electric feeder lines imbedded and interconnected from rail guideway segment to segment; and
a rail guideway support column of proportionate form, gauge, segment and material in substantiation of high speed hybrid transit vehicle modality thereupon; and
a rail guideway entrance and exit security and sequence scanning module; and
a rail guideway mounting and staging strip; and
a rail guideway solar/rainwater collector panel; and
a rail guideway column cistern; and
a rail guideway exit platform,
of part and with a hybrid transit vehicle embodied herein:
a chassis frame with arrangement for a partially rotating suspension;
an isolation dampened, wheel driven restorative braking generator/motor/idler carriage in plurality, centrally positioned under a vehicle chassis and on wheelbase axis and connected under a chassis suspension frame for alignment with and rotation on a rail guideway top surface;
a partially rotating, independent suspension in plurality of axles and wheels connected to chassis frame and of controlling mechanism addressing position of suspension for vehicle dual modality of ground-based surface wheel drive or wheel drive on surface of rail guideway with inclusion of engagement and disengagement coupling of drive and steering mechanism;
a partially rotating, steerable independent suspension in plurality of axles and wheels connected to chassis frame and of controlling mechanism addressing position of suspension for vehicle dual modality of ground-based surface wheel drive or wheel drive on surface of rail guideway with inclusion of engagement and disengagement coupling of drive and steering mechanism;
a steering rack linkage arrangement for engagement and disengagement from steering post linkage connected to partially rotating suspension;
a partially rotating idler carriage in plurality with power collector connected to under chassis for partial rotation synchronization with suspension and for rail guideway electric current engagement and for aligned securement of hybrid transit vehicle on rail guideway;
an actuator control arm in plurality, positioned substantially centered on chassis and at vehicle wheelbase axis in opposing duality, pivotally connected to chassis frame and extending to partially rotate suspension;
an electric motor with dual transfer case in parallel with motor and connected to chassis in transverse arrangement to chassis, positioned substantially centered on chassis at wheelbase axis,
in which the hybrid transit vehicle wheel axle axis is oriented in the vertical “Z” axis for wheel drive and power engagement on vertical surface of rail guideway; and in which the Hybrid transit vehicle wheel axle is oriented in the horizontal “X” axis for ground-based surface wheel drive.

6. The hybrid transit system of claim 2, in which the hybrid transit vehicle is scanned upon rail guideway entrance with a plurality of devises and in communication with the hybrid transit vehicle and the hybrid transit vehicle system.

7. The hybrid transit system of claim 2, in which the hybrid transit vehicle occupant data may link with the hybrid transit vehicle and the hybrid transit vehicle system.

8. The hybrid transit system of claim 2, in which the hybrid transit vehicle specific dynamic or static operational data may link with the hybrid transit vehicle system.

9. The hybrid transit system of claim 2, in which the hybrid transit vehicle occupant data may be transmitted or received as feature of hybrid transit system column.
